(19) United States
(12) Patent Application Publication
(10) Pub. No.: US 2024/0276427 A1
(43) Pub. Date: Aug. 15, 2024

(54) DETERMINING CANDIDATE POSITIONING ANCHOR

(71) Applicant: Nokia Technologies Oy, Espoo (FI)

(72) Inventors: Stepan KUCERA, Munich (DE); Taylan SAHIN, Munich (DE); Diomidis MICHALOPOULOS, Munich (DE); Prajwal KESHAVAMURTHY, Munich (DE)

(21) Appl. No.: 18/438,953

(22) Filed: Feb. 12, 2024

(30) Foreign Application Priority Data
Feb. 14, 2023 (GB) 2302071.2

(51) Int. Cl. H04W 64/00; H04B 17/336; H04L 5/00; H04W 8/00

(52) U.S. Cl. CPC H04W 64/00; H04B 17/336; H04L 5/0051; H04W 8/005

(57) ABSTRACT

Disclosed is a method comprising receiving, by an apparatus, information indicating at least one active positioning anchor configured to support positioning of one or more other apparatuses, wherein the information is received from at least one of: the at least one active positioning anchor, the one or more other apparatuses, a location management entity, or a network node; determining, by the apparatus, based on the information and one or more conditions, at least one candidate positioning anchor from one or more discovered candidate positioning anchors for supporting positioning of the apparatus, wherein the at least one candidate positioning anchor comprises the at least one active positioning anchor or at least one inactive positioning anchor; and indicating, by the apparatus, to the location management entity, a discovery of the at least one candidate positioning anchor.

### FIELD

The following example embodiments relate to wireless communication and to positioning.

### BACKGROUND

Positioning is a process that may be used to estimate a location of a user device. However, positioning involves usage of network resources. As resources are limited, it is desirable to optimize the usage of network resources.

### BRIEF DESCRIPTION

The scope of protection sought for various example embodiments is set out by the independent claims. The example embodiments and features, if any, described in this specification that do not fall under the scope of the independent claims are to be interpreted as examples useful for understanding various embodiments.

According to an aspect, there is provided an apparatus comprising at least one processor, and at least one memory storing instructions that, when executed by the at least one processor, cause the apparatus at least to: receive information indicating at least one active positioning anchor configured to support positioning of one or more other apparatuses, wherein the information is received from at least one of: the at least one active positioning anchor, the one or more other apparatuses, a location management entity, or a network node; determine, based on the information and one or more conditions, at least one candidate positioning anchor from one or more discovered candidate positioning anchors for supporting positioning of the apparatus, wherein the at least one candidate positioning anchor comprises the at least one active positioning anchor or at least one inactive positioning anchor; and indicate, to the location management entity, a discovery of the at least one candidate positioning anchor.

According to another aspect, there is provided an apparatus comprising: means for receiving information indicating at least one active positioning anchor configured to support positioning of one or more other apparatuses, wherein the information is received from at least one of: the at least one active positioning anchor, the one or more other apparatuses, a location management entity, or a network node; means for determining, based on the information and one or more conditions, at least one candidate positioning anchor from one or more discovered candidate positioning anchors for supporting positioning of the apparatus, wherein the at least one candidate positioning anchor comprises the at least one active positioning anchor or at least one inactive positioning anchor; and means for indicating, to the location management entity, a discovery of the at least one candidate positioning anchor.

According to another aspect, there is provided a method comprising: receiving, by an apparatus, information indicating at least one active positioning anchor configured to support positioning of one or more other apparatuses, wherein the information is received from at least one of: the at least one active positioning anchor, the one or more other apparatuses, a location management entity, or a network node; determining, by the apparatus, based on the information and one or more conditions, at least one candidate positioning anchor from one or more discovered candidate positioning anchors for supporting positioning of the apparatus, wherein the at least one candidate positioning anchor comprises the at least one active positioning anchor or at least one inactive positioning anchor; and indicating, by the apparatus, to the location management entity, a discovery of the at least one candidate positioning anchor.

According to another aspect, there is provided a computer program comprising instructions which, when executed by an apparatus, cause the apparatus to perform at least the following: receiving information indicating at least one active positioning anchor configured to support positioning of one or more other apparatuses, wherein the information is received from at least one of: the at least one active positioning anchor, the one or more other apparatuses, a location management entity, or a network node; determining, based on the information and one or more conditions, at least one candidate positioning anchor from one or more discovered candidate positioning anchors for supporting positioning of the apparatus, wherein the at least one candidate positioning anchor comprises the at least one active positioning anchor or at least one inactive positioning anchor; and indicating, to the location management entity, a discovery of the at least one candidate positioning anchor.

According to another aspect, there is provided a computer readable medium comprising program instructions which, when executed by an apparatus, cause the apparatus to perform at least the following: receiving information indicating at least one active positioning anchor configured to support positioning of one or more other apparatuses, wherein the information is received from at least one of: the at least one active positioning anchor, the one or more other apparatuses, a location management entity, or a network node; determining, based on the information and one or more conditions, at least one candidate positioning anchor from one or more discovered candidate positioning anchors for supporting positioning of the apparatus, wherein the at least one candidate positioning anchor comprises the at least one active positioning anchor or at least one inactive positioning anchor; and indicating, to the location management entity, a discovery of the at least one candidate positioning anchor.

According to another aspect, there is provided a non-transitory computer readable medium comprising program instructions which, when executed by an apparatus, cause the apparatus to perform at least the following: receiving information indicating at least one active positioning anchor configured to support positioning of one or more other apparatuses, wherein the information is received from at least one of: the at least one active positioning anchor, the one or more other apparatuses, a location management entity, or a network node; determining, based on the information and one or more conditions, at least one candidate positioning anchor from one or more discovered candidate positioning anchors for supporting positioning of the apparatus, wherein the at least one candidate positioning anchor comprises the at least one active positioning anchor or at least one inactive positioning anchor; and indicating, to the location management entity, a discovery of the at least one candidate positioning anchor.

According to another aspect, there is provided an apparatus comprising at least one processor, and at least one memory storing instructions that, when executed by the at least one processor, cause the apparatus at least to: determine one or more conditions for assisting a user device to determine at least one candidate positioning anchor for supporting positioning of the user device, wherein the at least one candidate positioning anchor comprises at least one active positioning anchor or at least one inactive positioning anchor; transmit, to the user device, information indicating the one or more conditions; and transmit, to the user device, information indicating the at least one active positioning anchor for assisting the user device to determine the at least one candidate positioning anchor, the at least one active positioning anchor configured to support positioning of one or more other user devices.

According to another aspect, there is provided an apparatus comprising: means for determining one or more conditions for assisting a user device to determine at least one candidate positioning anchor for supporting positioning of the user device, wherein the at least one candidate positioning anchor comprises at least one active positioning anchor or at least one inactive positioning anchor; means for transmitting, to the user device, information indicating the one or more conditions; and means for transmitting, to the user device, information indicating the at least one active positioning anchor for assisting the user device to determine the at least one candidate positioning anchor, the at least one active positioning anchor configured to support positioning of one or more other user devices.

According to another aspect, there is provided a method comprising: determining one or more conditions for assisting a user device to determine at least one candidate positioning anchor for supporting positioning of the user device, wherein the at least one candidate positioning anchor comprises at least one active positioning anchor or at least one inactive positioning anchor; transmitting, to the user device, information indicating the one or more conditions; and transmitting, to the user device, information indicating the at least one active positioning anchor for assisting the user device to determine the at least one candidate positioning anchor, the at least one active positioning anchor configured to support positioning of one or more other user devices.

According to another aspect, there is provided a computer program comprising instructions which, when executed by an apparatus, cause the apparatus to perform at least the following: determining one or more conditions for assisting a user device to determine at least one candidate positioning anchor for supporting positioning of the user device, wherein the at least one candidate positioning anchor comprises at least one active positioning anchor or at least one inactive positioning anchor; transmitting, to the user device, information indicating the one or more conditions; and transmitting, to the user device, information indicating the at least one active positioning anchor for assisting the user device to determine the at least one candidate positioning anchor, the at least one active positioning anchor configured to support positioning of one or more other user devices.

According to another aspect, there is provided a computer readable medium comprising program instructions which, when executed by an apparatus, cause the apparatus to perform at least the following: determining one or more conditions for assisting a user device to determine at least one candidate positioning anchor for supporting positioning of the user device, wherein the at least one candidate positioning anchor comprises at least one active positioning anchor or at least one inactive positioning anchor; transmitting, to the user device, information indicating the one or more conditions; and transmitting, to the user device, information indicating the at least one active positioning anchor for assisting the user device to determine the at least one candidate positioning anchor, the at least one active positioning anchor configured to support positioning of one or more other user devices.

According to another aspect, there is provided a non-transitory computer readable medium comprising program instructions which, when executed by an apparatus, cause the apparatus to perform at least the following: determining one or more conditions for assisting a user device to determine at least one candidate positioning anchor for supporting positioning of the user device, wherein the at least one candidate positioning anchor comprises at least one active positioning anchor or at least one inactive positioning anchor; transmitting, to the user device, information indicating the one or more conditions; and transmitting, to the user device, information indicating the at least one active positioning anchor for assisting the user device to determine the at least one candidate positioning anchor, the at least one active positioning anchor configured to support positioning of one or more other user devices.

### LIST OF DRAWINGS

In the following, various example embodiments will be described in greater detail with reference to the accompanying drawings, in which

FIG. 1 illustrates an example of a wireless communication network;

FIG. 2 illustrates an example of a system;

FIG. 3 illustrates a flow chart;

FIG. 4 illustrates a flow chart;

FIG. 5 illustrates a signal flow diagram;

FIG. 6 illustrates a signal flow diagram;

FIG. 7 illustrates a signal flow diagram;

FIG. 8 illustrates a signal flow diagram;

FIG. 9 illustrates an example of an apparatus;

FIG. 10 illustrates an example of an apparatus; and

FIG. 11 illustrates an example of an apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different example embodiments will be described using an example of a wireless communication network to which the example embodiments may be applied. The wireless communication network may comprise a radio access network based on one or more radio access technologies, such as long term evolution advanced (LTE Advanced, LTE-A), new radio (NR, 5G), beyond 5G, or sixth generation (6G) without restricting the example embodiments to such radio access technologies, however. Some examples of radio access networks include the universal mobile telecommunications system (UMTS) radio access network (UTRAN), the Evolved Universal Terrestrial Radio Access network (E-UTRA), or the next generation radio access network (NG-RAN). The wireless communication network may further comprise a core network. Some example embodiments may also be applied to network functions of the core network.

It is obvious for a person skilled in the art that some example embodiments may also be applied to other kinds of wireless communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

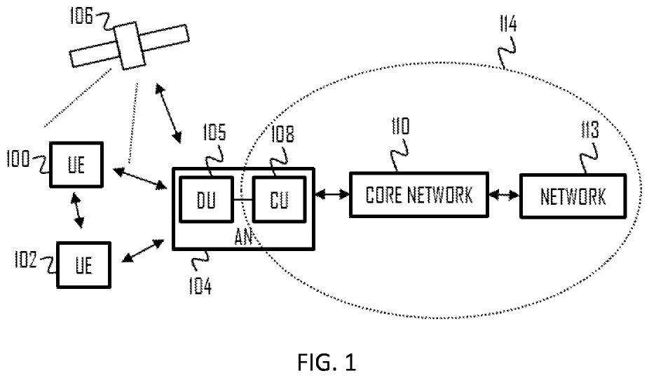

FIG. 1 depicts an example of a simplified wireless communication network showing some physical and logical entities. The connections shown in FIG. 1 may be physical connections or logical connections. It is apparent to a person skilled in the art that the wireless communication network may also comprise other physical and logical entities than those shown in FIG. 1.

The example embodiments described herein are not, however, restricted to the wireless communication network given as an example but a person skilled in the art may apply the embodiments described herein to other wireless communication networks provided with necessary properties.

The example wireless communication network shown in FIG. 1 includes an access network, such as a radio access network (RAN), and a core network 110.

FIG. 1 shows user equipment (UE) 100, 102 configured to be in a wireless connection on one or more communication channels in a radio cell with an access node (AN) 104 of an access network. The AN 104 may be an evolved Node B (abbreviated as eNB or eNodeB) or a next generation Node B (abbreviated as gNB or gNodeB), providing the radio cell. The wireless connection (e.g., radio link) from a UE to the access node 104 may be called uplink (UL) or reverse link, and the wireless connection (e.g., radio link) from the access node to the UE may be called downlink (DL) or forward link. UE 100 may also communicate directly with UE 102, and vice versa, via a wireless connection generally referred to as a sidelink (SL). It should be appreciated that the access node 104 or its functionalities may be implemented by using any node, host, server or access point etc. entity suitable for providing such functionalities.

The access network may comprise more than one access node, in which case the access nodes may also be configured to communicate with one another over links, wired or wireless. These links between access nodes may be used for sending and receiving control plane signaling and also for routing data from one access node to another access node.

The access node may comprise a computing device configured to control the radio resources of the access node. The access node may also be referred to as a base station, a base transceiver station (BTS), an access point, a radio access node or any other type of node capable of being in a wireless connection with a UE (e.g., UEs 100, 102). The access node may include or be coupled to transceivers. From the transceivers of the access node, a connection may be provided to an antenna unit that establishes bi-directional radio links to UEs 100, 102. The antenna unit may comprise an antenna or antenna element, or a plurality of antennas or antenna elements.

The access node 104 may further be connected to a core network (CN) 110. The core network 110 may comprise an evolved packet core (EPC) network and/or a 5th generation core network (5GC). The access node 104 may be connected to the CN 110 comprising network entities of an EPC, such as a serving gateway (S-GW for routing and forwarding data packets), a packet data network gateway (P-GW) for providing connectivity of UEs to external packet data networks, and a mobility management entity (MME). Alternatively, or additionally, the access node 104 may be connected to the CN 110 comprising network functions of a 5GC, such as a user plane function (UPF), and an access and mobility management function (AMF).

With respect to positioning, the core network 110 may comprise a 5GC having a service-based architecture. The 5GC may comprise various network functions, including an AMF and a location management function (LMF). The AMF may be configured to provide location information for call processing, mobility policy enforcement, and charging purposes to other network functions in the core network 110 and to other entities requesting for positioning of UEs. The AMF may receive and manage location requests from several entities: mobile-originated location requests (MO-LR) received from the UEs and mobile-terminated location requests (MT-LR) destined for other functions of the core network or the access network. The AMF may select the LMF for a given request and use its positioning service to trigger a positioning session. The LMF may then carry out the positioning upon receiving such a request from the AMF. The LMF may manage the resources and timing of positioning activities. The LMF may obtain location information for a UE with at least one of the following ways: by sending a Namf_Communication service request via the NL1 interface to one or more access nodes for network-based positioning; or by communicating with the UE over the N1 interface for UE-based or UE-assisted positioning. The location information obtained by the LMF may include an estimation of the location of the UE and, additionally, the LMF may also estimate movement or accuracy of the location information when requested. Connection-wise, the AMF may be between the access node and the LMF and, thus, closer to the access nodes than the LMF.

The core network 110 may also be able to communicate with one or more external networks 113, such as a public switched telephone network or the Internet, or utilize services provided by them. For example, in 5G wireless communication networks, the UPF of the core network 110 may be configured to communicate with an external data network via an N6 interface. In LTE wireless communication networks, the P-GW of the core network 110 may be configured to communicate with an external data network.

The illustrated UE 100, 102 is one type of an apparatus to which resources on the air interface may be allocated and assigned. The UE 100, 102 may also be called a wireless communication device, a subscriber unit, a mobile station, a remote terminal, an access terminal, a user terminal, a terminal device, or a user device just to mention but a few names. The UE may be a computing device operating with or without a subscriber identification module (SIM), including, but not limited to, the following types of computing devices: a mobile phone, a smartphone, a personal digital assistant (PDA), a handset, a computing device comprising a wireless modem (e.g., an alarm or measurement device, etc.), a laptop computer, a desktop computer, a tablet, a game console, a notebook, a multimedia device, a reduced capability (RedCap) device, a wearable device (e.g., a watch, earphones or eyeglasses) with radio parts, a sensor comprising a wireless modem, or any computing device comprising a wireless modem integrated in a vehicle.

It should be appreciated that a UE may also be a nearly exclusive uplink-only device, of which an example may be a camera or video camera loading images or video clips to a network. A UE may also be a device having capability to operate in an Internet of Things (IoT) network, which is a scenario in which objects may be provided with the ability to transfer data over a network without requiring human-to-human or human-to-computer interaction. The UE may also utilize cloud. In some applications, the computation may be carried out in the cloud or in another UE.

The wireless communication network may also be able to support the usage of cloud services, for example at least part of core network operations may be carried out as a cloud service (this is depicted in FIG. 1 by “cloud” 114). The communication system may also comprise a central control entity, or the like, providing facilities for wireless communication networks of different operators to cooperate for example in spectrum sharing.

5G enables using multiple input-multiple output (MIMO) antennas in the access node 104 and/or the UE 100, 102, many more base stations or access nodes than an LTE network (a so-called small cell concept), including macro sites operating in co-operation with smaller stations and employing a variety of radio technologies depending on service needs, use cases and/or spectrum available. 5G wireless communication networks may support a wide range of use cases and related applications including video streaming, augmented reality, different ways of data sharing and various forms of machine type applications (such as (massive) machine-type communications (mMTC), including vehicular safety, different sensors and real-time control.

In 5G wireless communication networks, access nodes and/or UEs may have multiple radio interfaces, namely below 6 GHz, cmWave and mmWave, and also being integrable with existing legacy radio access technologies, such as the LTE. Integration with the LTE may be implemented, for example, as a system, where macro coverage may be provided by the LTE, and 5G radio interface access may come from small cells by aggregation to the LTE. In other words, a 5G wireless communication network may support both inter-RAT operability (such as LTE-5G) and inter-RI operability (inter-radio interface operability, such as below 6 GHz-cmWave-mmWave). One of the concepts considered to be used in 5G wireless communication networks may be network slicing, in which multiple independent and dedicated virtual sub-networks (network instances) may be created within the substantially same infrastructure to run services that have different requirements on latency, reliability, throughput and mobility.

In some example embodiments, an access node (e.g., access node 104) may comprise: a radio unit (RU) comprising a radio transceiver (TRX), i.e., a transmitter (Tx) and a receiver (Rx); one or more distributed units (DUs) 105 that may be used for the so-called Layer 1 (L1) processing and real-time Layer 2 (L2) processing; and a central unit (CU) 108 (also known as a centralized unit) that may be used for non-real-time L2 and Layer 3 (L3) processing. The CU 108 may be connected to the one or more DUs 105 for example via an F1 interface. Such an embodiment of the access node may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU 108 may be a logical node hosting radio resource control (RRC), service data adaptation protocol (SDAP) and/or packet data convergence protocol (PDCP), of the NR protocol stack for an access node. The DU 105 may be a logical node hosting radio link control (RLC), medium access control (MAC) and/or physical (PHY) layers of the NR protocol stack for the access node. The operations of the DU may be at least partly controlled by the CU. The CU may comprise a control plane (CU-CP), which may be a logical node hosting the RRC and the control plane part of the PDCP protocol of the NR protocol stack for the access node. The CU may further comprise a user plane (CU-UP), which may be a logical node hosting the user plane part of the PDCP protocol and the SDAP protocol of the CU for the access node.

Cloud computing systems may also be used to provide the CU 108 and/or DU 105. A CU provided by a cloud computing system may be referred to as a virtualized CU (vCU). In addition to the vCU, there may also be a virtualized DU (vDU) provided by a cloud computing system. Furthermore, there may also be a combination, where the DU may be implemented on so-called bare metal solutions, for example application-specific integrated circuit (ASIC) or customer-specific standard product (CSSP) system-on-a-chip (SoC).

Edge cloud may be brought into the access network (e.g., RAN) by utilizing network function virtualization (NFV) and software defined networking (SDN). Using edge cloud may mean access node operations to be carried out, at least partly, in a computing system operationally coupled to a remote radio head (RRH) or a radio unit (RU) of an access node. It is also possible that access node operations may be performed on a distributed computing system or a cloud computing system located at the access node. Application of cloud RAN architecture enables RAN real-time functions being carried out at the access network (e.g., in a DU 105) and non-real-time functions being carried out in a centralized manner (e.g., in a CU 108).

It should also be understood that the distribution of functions between core network operations and access node operations may differ in future wireless communication networks compared to that of the LTE or 5G, or even be non-existent. Some other technology advancements that may be used include big data and all-IP, which may change the way wireless communication networks are being constructed and managed. 5G (or new radio, NR) wireless communication networks may support multiple hierarchies, where multi-access edge computing (MEC) servers may be placed between the core network 110 and the access node 104. It should be appreciated that MEC may be applied in LTE wireless communication networks as well.

A 5G wireless communication network (“5G network”) may also comprise a non-terrestrial communication network, such as a satellite communication network, to enhance or complement the coverage of the 5G radio access network. For example, satellite communication may support the transfer of data between the 5G radio access network and the core network, enabling more extensive network coverage. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). A given satellite 106 in the mega-constellation may cover several satellite-enabled network entities that create on-ground cells. The on-ground cells may be created through an on-ground relay access node or by an access node 104 located on-ground or in a satellite.

It is obvious for a person skilled in the art that the access node 104 depicted in FIG. 1 is just an example of a part of an access network (e.g., a radio access network) and in practice, the access network may comprise a plurality of access nodes, the UEs 100, 102 may have access to a plurality of radio cells, and the access network may also comprise other apparatuses, such as physical layer relay access nodes or other entities. At least one of the access nodes may be a Home eNodeB or a Home gNodeB. A Home gNodeB or a Home eNodeB is a type of access node that may be used to provide indoor coverage inside a home, office, or other indoor environment.

Additionally, in a geographical area of an access network (e.g., a radio access network), a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The access node(s) of FIG. 1 may provide any kind of these cells. A cellular radio network may be implemented as a multilayer access networks including several kinds of radio cells. In multilayer access networks, one access node may provide one kind of a radio cell or radio cells, and thus a plurality of access nodes may be needed to provide such a multilayer access network.

For fulfilling the need for improving performance of access networks, the concept of “plug-and-play” access nodes may be introduced. An access network which may be able to use “plug-and-play” access nodes, may include, in addition to Home eNodeBs or Home gNodeBs, a Home Node B gateway, or HNB-GW (not shown in FIG. 1). An HNB-GW, which may be installed within an operator's access network, may aggregate traffic from a large number of Home eNodeBs or Home gNodeBs back to a core network of the operator.

Positioning is a process that may be used to estimate a position (e.g., a geographic location) of a UE. Herein the UE to be positioned is referred to as a target UE or target user device. For example, the positioning techniques used in NR may be based on at least one of the following: time difference of arrival (TDoA), time of arrival (TOA), time of departure (TOD), round trip time (RTT), angle of departure (AoD), angle of arrival (AoA), and/or carrier phase.

The position of the target UE may be estimated in an absolute manner (in case of absolute positioning) or in a relative manner (in case of relative positioning).

Absolute positioning refers to estimating the position of the target UE in two-dimensional or three-dimensional geographic coordinates (e.g., latitude, longitude, and/or elevation) within a coordinate system.

Relative positioning refers to estimating the position of the target UE relative to one or more network nodes or relative to one or more other UEs.

In Uu positioning (UL and/or DL positioning), multiple transmission and reception points (TRPs) in known locations may transmit one or more positioning reference signals (PRS) to the target UE, and/or receive and measure one or more positioning reference signals from the target UE. In the uplink, a sounding reference signal (SRS) may be used as a positioning reference signal. For example, multilateration techniques may then be used to localize (i.e., position) the target UE with respect to the TRPs. At least one TRP out of these TRPs may be used as a positioning anchor, and the differences in TDoA may be computed with respect to this positioning anchor. The positioning anchor may also be referred to as an anchor, anchor node, multilateration anchor, or reference point.

In network-based positioning, the position of the target UE is determined or calculated by a network entity (e.g., gNB or LMF). For network-based positioning, the target UE may report information to the network entity to enable determining the position of the target UE.

In UE-based positioning, the position of the target UE is determined or calculated by the target UE or another UE.

Sidelink (SL) positioning refers to the positioning approach, where the target UE utilizes the sidelink (i.e., the direct device-to-device link) to position itself, either in an absolute manner (in case of absolute positioning) or in a relative manner (in case of relative positioning). SL positioning may be beneficial in, for example (but not limited to), the following use cases: public safety, vehicle-to-everything (V2X), and industrial internet of things (IIoT).

SL positioning may be based on the transmission of a sidelink positioning reference signal (SL-PRS) by multiple anchor UEs (e.g., at least three anchor UEs), wherein the SL-PRS is received and measured by a target UE to enable localization of the target UE (e.g., using SL TDoA techniques) within certain latency and accuracy requirements of the corresponding SL positioning session. Alternatively, or additionally, the target UE may transmit SL-PRS to be received and measured by the anchor UEs. The exchange of SL-PRS between the target UE and anchor UEs may be used, for example, in SL RTT based positioning techniques.

An anchor UE may be defined as a UE supporting positioning of the target UE, for example by transmitting and/or receiving reference signals (e.g., SL-PRS) for positioning over the SL interface. This may be similar to Uu positioning, where gNBs may serve as positioning anchors transmitting and/or receiving reference signals for positioning. Herein an anchor UE may also be referred to as a positioning anchor.

SL-PRS refers to a reference signal transmitted over SL for positioning purposes. SL-PRS may be configured in terms of various parameters including time-frequency resources, such as bandwidth and periodicity; directivity-related parameters such as beam direction, beam width, number of beams, etc.; and transmit power. Such parameters may be collectively referred to as an SL-PRS (pre)configuration.

In a network coverage or partial coverage scenario, the SL-PRS configuration may be determined by a network entity (e.g., LMF or gNB). In an out-of-coverage scenario, the SL-PRS configuration may be (pre)configured and/or determined by UEs autonomously.

For UE-assisted positioning (in SL positioning and Uu positioning), the target UE may utilize the sidelink to obtain positioning measurements and report the measurements to a network entity such as an LMF. Sidelink positioning may also be used to obtain ranging information. Ranging means determination of the distance between two UEs and/or the direction of one UE from the other one via direct device connection.

In network-assisted sidelink positioning, the network (e.g., LMF) is in control of the sidelink positioning. In this case, the network may perform, for example, anchor (re)selection and/or SL-PRS (re)configuration, etc. For network-assisted sidelink positioning, the UEs may report information, such as sidelink positioning measurements, to the network.

In network-assisted sidelink positioning (e.g., based on SL TDOA, SL multi-RTT, etc.), the network (e.g., LMF) may be in full or partial control of the SL positioning. For example, the LMF may be responsible for anchor (re)selection based on at least the measurement information reported from the target UE. Anchor (re)selection refers to the process of determining which positioning anchors to use for supporting the positioning session of the target UE.

However, anchor (re)selection is not a trivial task, as it directly impacts the positioning accuracy. For example, if the selected positioning anchors are colinear with the target UE, the target UE may experience high geometric dilution of precision (GDOP), and the positioning accuracy may decrease significantly. Furthermore, the radio link quality between a given positioning anchor and the target UE impacts the reception quality of the positioning reference signal at the target UE, and hence impacts the positioning accuracy as well. To this end, the target UE may report information related to candidate positioning anchors to the LMF, so that the LMF can perform informed anchor (re)selection to meet the positioning accuracy requirements of the target UE. Herein candidate positioning anchors refer to potential positioning anchors that are not yet used to support the positioning of the target UE, but have the potential to be used to support the positioning of the target UE.

Multiple (at least three) positioning anchors with known locations may be needed to localize a given target UE by transmitting and/or measuring positioning reference signals. The current process of selecting or acquiring a positioning anchor may comprise a discovery phase, selection phase and activation phase, which makes it a relatively complex and lengthy process.

For anchor discovery in sidelink positioning, the candidate positioning anchors (e.g., candidate anchor UEs) may transmit anchor discovery messages over the sidelink (i.e., PC5 interface). The target UE may receive the discovery messages and report the corresponding measurements (including discovery information, such as anchor UE location) to the LMF to assist in anchor (re)selection.

The current anchor selection process may not involve any reuse of positioning anchors in the sense that positioning anchors that are already utilized for positioning one target UE could also be used with reduced discovery effort to position another target UE. Instead, the current anchor selection process involves a flat discovery process for positioning anchors, which makes it inefficient for example in scenarios with a high density of candidate positioning anchors. Moreover, the current process may use unicast as a baseline, meaning that a target UE would have to communicate with candidate positioning anchors on an individual basis, causing significant overhead and latency.

There may be at least two types of sidelink positioning: session-based positioning and session-less positioning. However, from the anchor selection perspective, neither of these two options are ideal due to a trade-off between performance, complexity and delay.

Session-based sidelink positioning may offer some performance guarantees (e.g., baseline positioning accuracy). Unicast may be used as a communication baseline in session-based sidelink positioning, so that the session setup together with anchor selection may cause significant overhead and delay during session setup. In this case, anchor selection may be carried out in multiple steps, because the target UE would have to communicate with the candidate positioning anchors in a one-to-one manner and coordinate with the LMF or server UE.

On the other hand, in session-less positioning, the session setup delay is not a factor, but just some best-effort positioning services may be offered. For example, not all positioning anchors may always perform their transmission or measurement tasks as needed. Broadcast or groupcast could theoretically be used to disseminate the assistance data and/or measurement results, and in this way reduce the latency of unicast communications. However, an issue with sidelink broadcast or groupcast communication is the lack of privacy and security, which may prevent its usage in practice. Also, there may be no safeguards ensuring efficient anchor selection. Anchors would just be selected using basic discovery mechanisms, i.e., based on their presence. In this way, no control of GDOP or resource efficiency would be achieved.

Some example embodiments relate to positioning anchor selection for example in Uu-based positioning or hybrid (i.e., Uu+PC5) sidelink positioning. Some example embodiments may address the above issue by providing a procedure that reduces the anchor discovery effort.

Some example embodiments are based on the observation that simultaneously active target UEs could share or reuse already active positioning anchors, instead of undergoing a lengthy discovery, selection, configuration, and activation process of new positioning anchors.

Some example embodiments may enable signaling with an “LMF-to-UE” component and “UE-to-UE” component, wherein target UEs by default strive to reuse already active positioning anchors to reduce delay as well as signaling and resource overhead. However, under some specific condition(s) (e.g., application priority or a high-priority need for positioning), new (inactive) positioning anchors may be allocated and activated.

Herein an active positioning anchor may be defined as a positioning anchor that is supporting positioning of one or more target UEs (e.g., the anchor is transmitting PRS that is measured by the one or more target UEs). An inactive positioning anchor may be defined as a potential positioning anchor that is not yet supporting positioning of any target UE, but has the potential to do so.

The sharing of active positioning anchors may be beneficial, as the PRS broadcasted from a given positioning anchor can be measured by multiple target UEs simultaneously, which may substantially reduce signaling overhead and delay. Another benefit may be better resource efficiency. More target UEs may be served with less positioning anchors, whereby lower PRS usage would contribute to lower interference, which would permit to use frequency-wise narrower PRSs without decreasing the positioning accuracy. The reuse of an active positioning anchor and/or the setup of a new (inactive) positioning anchor may be driven by one or more pre-defined or pre-configured conditions.

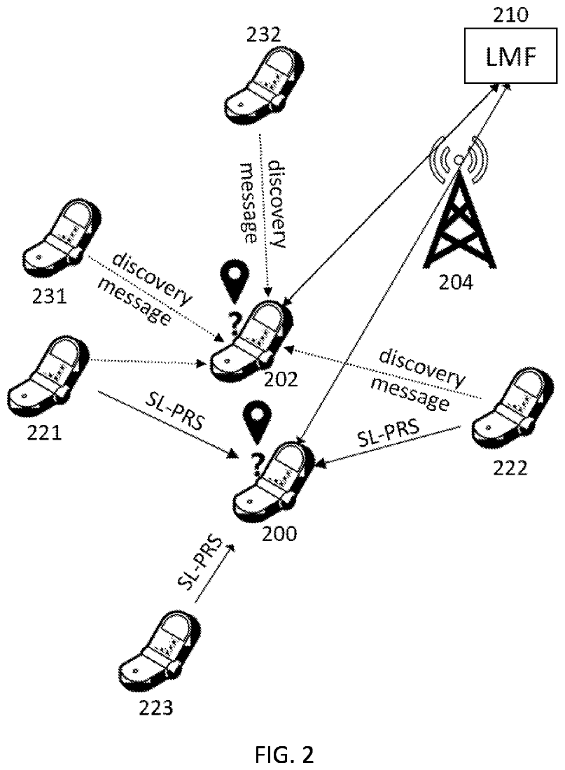

FIG. 2 illustrates an example of a system, to which some example embodiments may be applied. In this example, the system comprises a first target UE 200, a second target UE 202, a network node 204 (e.g., a gNB), an LMF 210, a first active positioning anchor 221, a second active positioning anchor 222, a third active positioning anchor 223, a first inactive positioning anchor 231, and a second inactive positioning anchor 232. For example, the positioning anchors may be anchor UEs.

FIG. 2 may be understood to depict a part of the wireless communication network of FIG. 1, but with greater accuracy with respect to a positioning scenario. The first target UE 200 may correspond to UE 100 of FIG. 1. The second target UE 202 may correspond to UE 102 of FIG. 1. The network node 204 may correspond to the access node 104 of FIG. 1. The LMF 210 may be comprised in the core network 110 of FIG. 1. FIG. 2 illustrates an example of a sidelink positioning scenario, where the first target UE 200 is performing a sidelink positioning session, i.e., receiving SL-PRS from three active anchor UEs 221, 222, 223 in order to determine the location of the first target UE 200. Here, the active anchor UEs 221, 222, 223 are said to provide SL-PRS assistance (including SL-PRS transmission) to the first target UE 200. The LMF 210 may be in full or partial control of the SL positioning. The LMF 210 is responsible for at least anchor (re)selection for a given target UE 200, 202 based at least on the sidelink measurement information reported from the target UE 200, 202 for example over the LTE positioning protocol (LPP). For example, the first target UE 200 may obtain the measurement information by measuring the SL-PRS and/or anchor discovery messages received from the active anchor UEs 221, 222, 223. The measurement information may comprise, for example, reference signal received power (RSRP) of the SL-PRS and/or anchor discovery messages.

In an example embodiment, the second target UE 202 and/or one or more positioning anchors 221, 222, 223, 231, 232 may be configured with one or more anchor selection condition(s) by means of signaling from one or more other UEs (e.g., from the first target UE 200 or first active anchor UE 221) and/or from the network node 204 or the LMF 210. For example, the second target UE 202 may use said condition(s) to control its interactions with one or more positioning anchors 221, 222, 223, 231, 232 (e.g., to determine whether to reuse one or more active positioning anchors 221, 222, 223 or not) and positioning performance, while the one or more positioning anchors 221, 222, 223, 231, 232 may adaptively assist with the anchor search of the second target UE 202 by providing information on their status with respect to said condition(s) (e.g., indicate “active status” in discovery procedure, if channel congestion is above a threshold to facilitate reuse).

The one or more conditions may be based on at least one of: geometric dilution of precision (GDOP), positioning accuracy, positioning integrity, one or more performance parameters, one or more performance guarantees, one or more performance requirements, a performance class, a type of a positioning-related application related to the target UE, a type of a positioning session related to the target UE, a type of the target UE, a priority of the positioning-related application, a priority of the positioning session, a priority of the target UE, a purpose of the positioning-related application, a purpose of the positioning session, or a purpose of the target UE, presence of one or more active positioning anchors, presence of one or more suitable positioning anchors (e.g., inactive but with allocated resources), channel congestion, channel occupancy, channel usage, interference, PRS availability, PRS usage, PRS strength, PRS signal-to-interference-plus-noise ratio (SINR), PRS type, resource pool type, resource configuration, resource parameters, participation in session-based positioning, participation in positioning with one or more performance guarantees, or participation in session-less positioning.

For example, the target UE 202 may be allowed to add an inactive positioning anchor 231, 232 as a candidate positioning anchor, if one or more of the following conditions are fulfilled: unsatisfactory GDOP or positioning accuracy or positioning integrity of the positioning process is detected, certain performance parameters or guarantees are required, a high priority of the localization call or the target UE 202 itself is detected (e.g., for emergency or rescue services), or when no active positioning anchors 221, 222, 223 are detected.

For determining whether to add an inactive positioning anchor, the target UE 202 may further check whether one or more of the following conditions are fulfilled: discovery of a new suitable positioning anchor (e.g., inactive but fully configured anchor that can be quickly reactivated), low channel congestion or occupancy or usage, i.e., an additional wide-band PRS of a new positioning anchor would not significantly contribute to overall congestion (low channel busy ratio) and interference (high SINR), and/or participation in session-based positioning with performance guarantees.

The actual positioning anchor activity may be indicated to and/or discovered by other network nodes using dedicated signaling or based on a standardized convention. For example, said indication or discovery may be implemented by using a suitable protocol for delivering explicit signaling (e.g., PRS sidelink control information, PRS itself, discovery message, assistance data), and/or implicit signaling (e.g., specific PRS sequence or resource pool). For example, the indication may be delivered in the form of an activity flag, activity time (e.g., time until activity ends, time from activity start), and/or re-selection priority. Some examples of the protocol may include proximity service (ProSe) (e.g., from an anchor UE), sidelink positioning protocol (SLPP) (e.g, for target UE), the LTE positioning protocol (LPP) (e.g., for LMF), or RRC (e.g., for gNB).

The activity indication and/or the one or more conditions may be adapted based on single-node or multi-node action as well as actual anchor activity. For example, PRS resource allocation and anchor activity (indication) may be controlled by the LMF 210 based on inputs from multiple UEs 200, 221, 222, 223, 231, 232 (e.g., extend activity time if anchor UE serves a new target UE added), or by anchor UE(s) 221, 222, 223, 231, 232 based on their own operating conditions (e.g., activity engagement while in session-based activity), or the target UE 202 based on its own operating conditions (e.g. “activity request” from session-less target UE to active anchor UE whose PRS the target UE exploits) or LMF instructions.

If the target UE 202 determines to reuse an active positioning anchor 221, 222, 223, the target UE 202 may engage in a discovery procedure (e.g., model-A or model-B discovery) with neighboring positioning anchors 221, 222, 223, 231, 232. The positioning anchors 221, 222, 223, 231, 232 may indicate their status regarding resource allocation and/or their activation to the target UE 202. For example, the positioning anchors 221, 222, 223, 231, 232 may indicate their anchor selection priority and/or PRS broadcast duration or remaining activity time to the target UE 202.

In case of model-A discovery, a given anchor UE 221, 222, 223, 231, 232 that is capable of positioning anchor functionality is considered to be transmitting a discovery message, which may include the location information of the respective anchor UE. When the target UE 202 detects those discovery messages (e.g., RSRP of the discovery message being above a certain threshold), the target UE 202 discovers that there are anchor UEs 221, 222, 223, 231, 232 in the vicinity, which are capable of positioning anchor functionality. Such identified anchor UEs 221, 222, 223, 231, 232 may be referred to as candidate positioning anchors, since those UEs have the potential to be a positioning anchor for the target UE 202.

In case of model-B discovery, the target UE 202 may transmit a discovery request message to one or more neighboring UEs 221, 222, 223, 231, 232 (e.g., by broadcast or groupcast or unicast) to indicate that the target UE 202 is requesting UEs, which are capable of positioning anchor functionality, to identify themselves to the target UE 202. Upon receiving the discovery request message, those UE(s) 221, 222, 223, 231, 232 that are capable of positioning anchor functionality may transmit a discovery response message to the target UE 202 to indicate that they are capable of positioning anchor functionality. The target UE 202 may then identify one or more of these UE(s) 221, 222, 223, 231, 232 as candidate positioning anchor(s).

Some example embodiments are described below using principles and terminology of 5G radio access technology without limiting the example embodiments to 5G radio access technology, however.

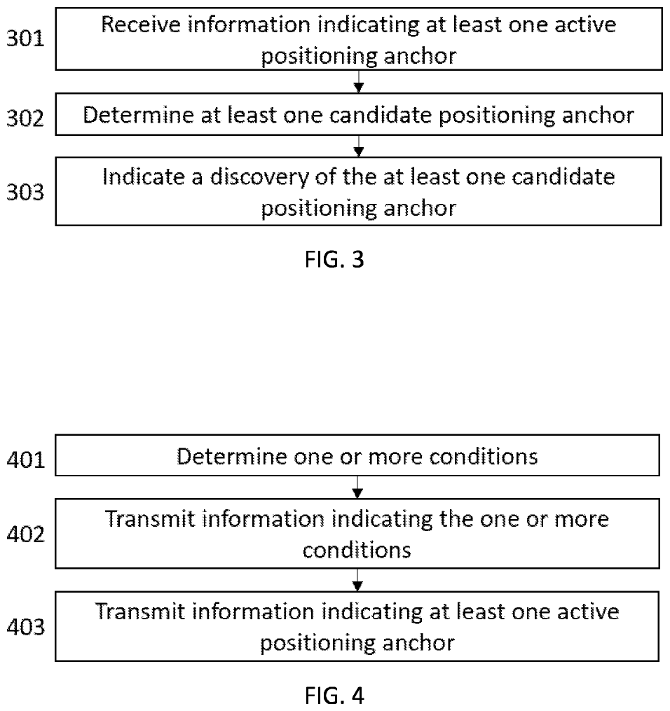

FIG. 3 illustrates a flow chart according to an example embodiment of a method performed by an apparatus. For example, the apparatus may be, or comprise, or be comprised in, a user device. The user device may also be called a wireless communication device, a subscriber unit, a mobile station, a remote terminal, an access terminal, a user terminal, a terminal device, user equipment (UE), target UE, or target user device. The user device may correspond to UE 100 of FIG. 1, or target UE 202 of FIG. 2.

Referring to FIG. 3, at 301, the apparatus receives information indicating at least one active positioning anchor configured to support positioning of one or more other apparatuses (e.g., one or more other target UEs), wherein the information is received from at least one of: the at least one active positioning anchor, the one or more other apparatuses, a location management entity, or a network node.

The network node may refer to, for example, an access node such as a gNB.

The location management entity may comprise, for example, a location management function (LMF) or a server UE. A server UE refers to a UE that is acting as a location server. The location management entity may be a separate device or network entity, or the apparatus itself may comprise the location management entity (e.g., the apparatus may be a server UE that is attempting to position itself). At 302, the apparatus determines, based on the information and one or more conditions, at least one candidate positioning anchor from one or more discovered candidate positioning anchors for supporting positioning of the apparatus, wherein the at least one candidate positioning anchor comprises the at least one active positioning anchor or at least one inactive positioning anchor. The one or more discovered candidate positioning anchors refer to candidate positioning anchor(s), from which the apparatus has received a discovery message. The one or more discovered candidate positioning anchors may comprise at least one of: the at least one active positioning anchor and/or the at least one inactive positioning anchor.

Herein a given positioning anchor or candidate positioning anchor may comprise, for example, one of: an anchor UE, a network node (e.g., a gNB), a road-side unit (RSU), or any other device capable of supporting the positioning of the apparatus. An RSU is a UE-type or gNB-type stationary infrastructure entity supporting vehicle-to-everything (V2X) applications, for example.

In one example, the information received in block 301 may indicate a remaining activity time or a positioning reference signal broadcast duration of the at least one active positioning anchor, wherein the at least one candidate positioning anchor may be determined based at least partly on the remaining activity time or the positioning reference signal broadcast duration of the at least one active positioning anchor.

Alternatively, or additionally, the information received in block 301 may indicate a priority of the at least one active positioning anchor relative to the at least one inactive positioning anchor, wherein the at least one candidate positioning anchor may be determined based at least partly on the priority.

Alternatively, or additionally, the apparatus may receive, from the at least one active positioning anchor, a message indicating a status of the at least one active positioning anchor with respect to at least one condition of the one or more conditions, wherein the at least one candidate positioning anchor may be determined based at least partly on the status of the at least one active positioning anchor.

The at least one candidate positioning anchor may comprise the at least one active positioning anchor based on the one or more conditions not being fulfilled. In other words, in case the one or more conditions are not fulfilled, the apparatus may select the at least one active positioning anchor as the at least one candidate positioning anchor.

Alternatively, the at least one candidate positioning anchor may comprise the at least one inactive positioning anchor based on the one or more conditions being fulfilled. In other words, in case the one or more conditions are fulfilled, the apparatus may select the at least one inactive positioning anchor as the at least one candidate positioning anchor.

For example, the one or more conditions may comprise at least one of: an estimated positioning accuracy improvement associated with the at least one active positioning anchor being below a threshold, or an estimated positioning error reduction associated with the at least one active positioning anchor being below a threshold.

Alternatively, or additionally, the one or more conditions may comprise at least one of: one or more performance parameters required from the at least one active positioning anchor not being available, one or more performance guarantees required from the at least one active positioning anchor not being available, one or more performance requirements required from the at least one active positioning anchor not being available, or a performance class required from the at least one active positioning anchor not being available.

Alternatively, or additionally, the one or more conditions may comprise at least one of: a type of a positioning-related application related to the apparatus, a type of a positioning session related to the apparatus, a type of the apparatus, a priority of the positioning-related application, a priority of the positioning session, a priority of the apparatus, a purpose of the positioning-related application, a purpose of the positioning session, or a purpose of the apparatus.

For example, if the type of the positioning-related application corresponds to an emergency application, such as an emergency localization call, 911 localization, or operator tracking, then the apparatus may be allowed to select the at least one inactive positioning anchor as the at least one candidate positioning anchor (instead of reusing the at least one active positioning anchor).

As another example, if the priority of the positioning session corresponds to a high-priority positioning request (e.g., an emergency request), then the apparatus may be allowed to select the at least one inactive positioning anchor as the at least one candidate positioning anchor (instead of reusing the at least one active positioning anchor).

As another example, if the priority of the positioning session corresponds to a low priority or normal priority (e.g., asset tracking), then the apparatus may select the at least one active positioning anchor as the at least one candidate positioning anchor (i.e., reuse the at least one active positioning anchor).

As another example, if the type of the positioning session corresponds to a reliable session offering some minimum positioning accuracy guarantees, then the apparatus may be allowed to select the at least one inactive positioning anchor as the at least one candidate positioning anchor (instead of reusing the at least one active positioning anchor).

As another example, if the type of the positioning session corresponds to a best-effort process without any positioning accuracy guarantees, then the apparatus may select the at least one active positioning anchor as the at least one candidate positioning anchor (i.e., reuse the at least one active positioning anchor).

As another example, if the priority of the apparatus corresponds to a high priority, such as a VIP subscriber or emergency equipment, then the apparatus may be allowed to select the at least one inactive positioning anchor as the at least one candidate positioning anchor (instead of reusing the at least one active positioning anchor).

As another example, if the priority of the apparatus corresponds to a low or normal priority, such as a regular subscriber (i.e., not VIP), then the apparatus may select the at least one active positioning anchor as the at least one candidate positioning anchor (i.e., reuse the at least one active positioning anchor).

Alternatively, or additionally, the one or more conditions may comprise at least one of: the at least one active positioning anchor not being detected, or the at least one inactive positioning anchor being detected.

Alternatively, or additionally, the one or more conditions may comprise at least one of: channel usage or channel occupancy or channel congestion being below a threshold, or interference being below a threshold.

Alternatively, or additionally, the one or more conditions may comprise at least one of: availability of a positioning reference signal at the at least one inactive positioning anchor, usage of the positioning reference signal at the at least one inactive positioning anchor, a strength of the positioning reference signal of the at least one inactive positioning anchor being above a threshold, a signal-to-interference-plus-noise ratio of the positioning reference signal of the at least one inactive positioning anchor being above a threshold, or a type of the positioning reference signal of the at least one inactive positioning anchor corresponding to a desired type.

While the at least one inactive positioning anchor is not currently serving any target UE, it may still (blindly) broadcast PRS, just in case some UE shows up in the area and passively monitors PRS (e.g., for quick ranging based on signal strength or angle of arrival).

Alternatively, or additionally, the one or more conditions may comprise at least one of: a resource pool type used by the apparatus, a resource configuration of the apparatus, or one or more resource parameters of the apparatus.

The resource pool refers to a specific part of the network bandwidth that is used to accommodate the PRS transmissions. For example, specific UE groups may be configured to share a given resource pool.

For example, if the apparatus is using a resource pool used by police or other emergency personnel, then the apparatus may be allowed to select the at least one inactive positioning anchor as the at least one candidate positioning anchor (instead of reusing the at least one active positioning anchor).

As another example, if the apparatus is using a resource pool used by regular subscribers, then the apparatus may select the at least one active positioning anchor as the at least one candidate positioning anchor (i.e., reuse the at least one active positioning anchor).

Alternatively, or additionally, the one or more conditions may comprise at least one of: participation of the apparatus in session-based positioning, participation of the apparatus in positioning with one or more performance guarantees, or the apparatus not participating in session-less positioning.

For example, if the apparatus is participating in session-less positioning, and the at least one active positioning anchor is detected, then the apparatus may select the at least one active positioning anchor as the at least one candidate positioning anchor (i.e., reuse the at least one active positioning anchor).

As another example, if the apparatus is participating in positioning with one or more performance guarantees, then the apparatus may be allowed to select the at least one inactive positioning anchor as the at least one candidate positioning anchor (instead of reusing the at least one active positioning anchor).

At 303, the apparatus indicates, to the location management entity, a discovery of the at least one candidate positioning anchor.

FIG. 4 illustrates a flow chart according to an example embodiment of a method performed by an apparatus. For example, the apparatus may be, or comprise, or be comprised in, a network node of a radio access network. The network node may correspond to the access node 104 of FIG. 1, or the network node 204 of FIG. 2. Alternatively, the method may be performed by an apparatus or a function, such as an LMF, of a core network. The LMF may correspond to the core network 110 of FIG. 1, or the LMF 210 of FIG. 2. Alternatively, the method may be performed by an apparatus such as a user device (e.g., an anchor UE or a target UE). The user device may correspond to UE 102 of FIG. 1, or one of the anchor UEs 221, 222, 223, 231, 232 of FIG. 2, or the target UE 200 of FIG. 2.

At 401, the apparatus determines determine one or more conditions for assisting a user device to determine at least one candidate positioning anchor for supporting positioning of the user device, wherein the at least one candidate positioning anchor comprises at least one active positioning anchor or at least one inactive positioning anchor.

Some examples of the one or more conditions are described above with reference to FIG. 3.

At 402, the apparatus transmits, to the user device, information indicating the one or more conditions.

At 403, the apparatus transmits, to the user device, information indicating the at least one active positioning anchor for assisting the user device to determine the at least one candidate positioning anchor, the at least one active positioning anchor configured to support positioning of one or more other user devices.

The information indicating the at least one active positioning anchor may be based on information received from the one or more other user devices (e.g., one or more other target UEs), or based on operating conditions of the apparatus. For example, the information may be based on positioning-related measurement information received from the one or more other user devices, wherein the positioning of the one or more other user devices may be supported by the at least one active positioning anchor. As another example, the apparatus itself may be the at least one active positioning anchor, in which case the information may be based on the operating conditions, such as active status (e.g., PRS transmission), of the at least one active positioning anchor.

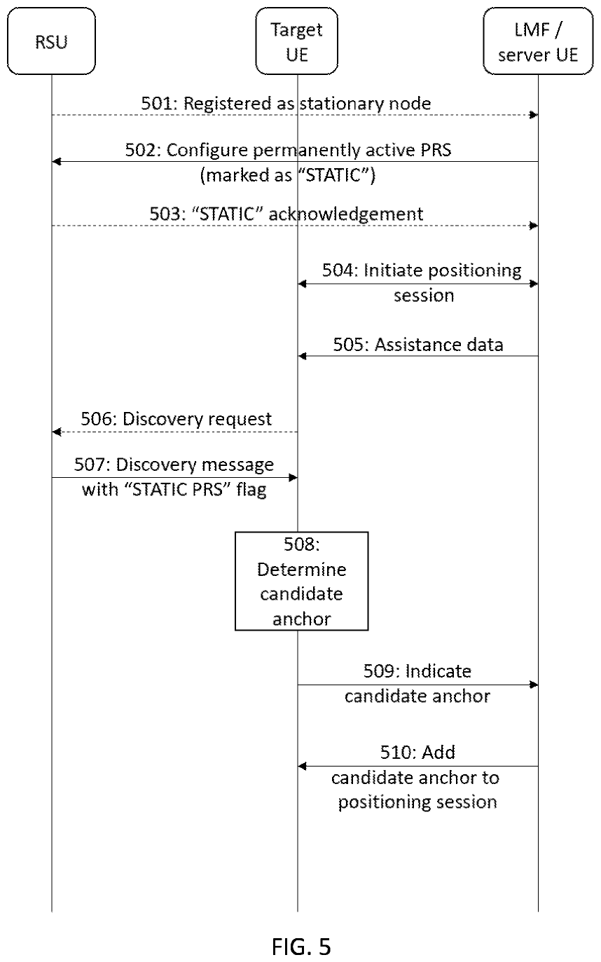

FIG. 5 illustrates a signal flow diagram according to an example embodiment. The target UE of FIG. 5 may correspond to UE 100 or 102 of FIG. 1, or the first target UE 200 or second target UE 202 of FIG. 2. The LMF or server UE of FIG. 5 may correspond to the core network 110 of FIG. 1, or the LMF 210 of FIG. 2. The RSU of FIG. 5 may correspond to at least one of the active positioning anchors 221, 222, 223 of FIG. 2.

Referring to FIG. 5, at 501, at least one active positioning anchor, such as a static RSU or static anchor UE, may transmit, to a location management entity, such as an LMF or server UE, a message for registering the at least one active positioning anchor as a permanently active stationary node (i.e., a permanently active positioning anchor).

At 502, the location management entity configures the at least one positioning anchor with permanently active PRS. In other words, the at least one active positioning anchor may be marked with a “STATIC” status. Based on the configuration, the at least one positioning anchor may be activated (i.e., start transmitting PRS or SL-PRS). Thus, the at least one positioning anchor may be referred to as at least one active positioning anchor.

At 503, the at least one active positioning anchor may transmit, to the location management, an acknowledgement to being marked with the “STATIC” status. At 504, the location management entity initiates a positioning session for positioning a target UE.

At 505, the location management entity may transmit assistance data to the target UE for example via LPP to assist the target UE with determining at least one candidate positioning anchor for the target UE.

For example, the assistance data may comprise information indicating the at least one active positioning anchor, which may be configured to support positioning of another target UE. The information may further indicate the “STATIC” status of the at least one active positioning anchor.

Alternatively, or additionally, the location management entity may determine one or more conditions for assisting the target UE to determine at least one candidate positioning anchor for supporting positioning of the target UE, in which case the assistance data may comprise information indicating the one or more conditions.

At 506, in case of model-B discovery, the target UE may transmit a discovery request message to the at least one active positioning anchor and at least one inactive positioning anchor (e.g., by broadcast or groupcast or unicast transmission). The discovery request message may further comprise a request for indicating whether the recipient is in “STATIC” status. However, it should be noted that the discovery request message may be optional. For example, it may not be used in model-A discovery.

At 507, the at least one active positioning anchor transmits a discovery message to the target UE to indicate that the at least one active positioning anchor is capable of supporting the positioning of the target UE. The discovery message may further indicate the “STATIC” status of the at least one active positioning anchor. The “STATIC” status may indicate that the at least one active positioning anchor is a permanently active positioning anchor (e.g., RSU or static UE).

For example, the discovery message may be transmitted in response to receiving the discovery request message from the target UE (in case of model-B discovery). Alternatively, in case of model-A discovery, the anchor may autonomously transmit the discovery message (e.g., by broadcasting it periodically).

At 508, the target UE determines, based on the information received at 505 and the one or more conditions, at least one candidate positioning anchor from one or more discovered candidate positioning anchors (e.g., the at least one active positioning anchor) for supporting positioning of the target UE, wherein the at least one candidate positioning anchor comprises the at least one active positioning anchor.

In other words, the target UE evaluates the one or more conditions to determine whether to reuse the at least one active positioning anchor, or to activate at least one inactive positioning anchor (i.e., a new anchor). The one or more conditions may be pre-defined or pre-configured at the target UE, or they may be indicated in the assistance data that may be received from the location management entity.

Some examples of the one or more conditions and how to apply them are described above with reference to FIG. 3.

At 509, the target UE transmits, to the location management entity, a message (e.g., anchor discovery report) indicating a discovery of the at least one candidate positioning anchor. The message may be transmitted for example via LPP.

At 510, in response to receiving the message from the target UE, the location management entity transmits (e.g., via LPP), to the target UE, an indication to add the at least one candidate positioning anchor to the positioning session of the target UE.

In other words, in case the at least one active positioning anchor is selected as the at least one candidate positioning anchor, the at least one active positioning anchor is reused for positioning the target UE.

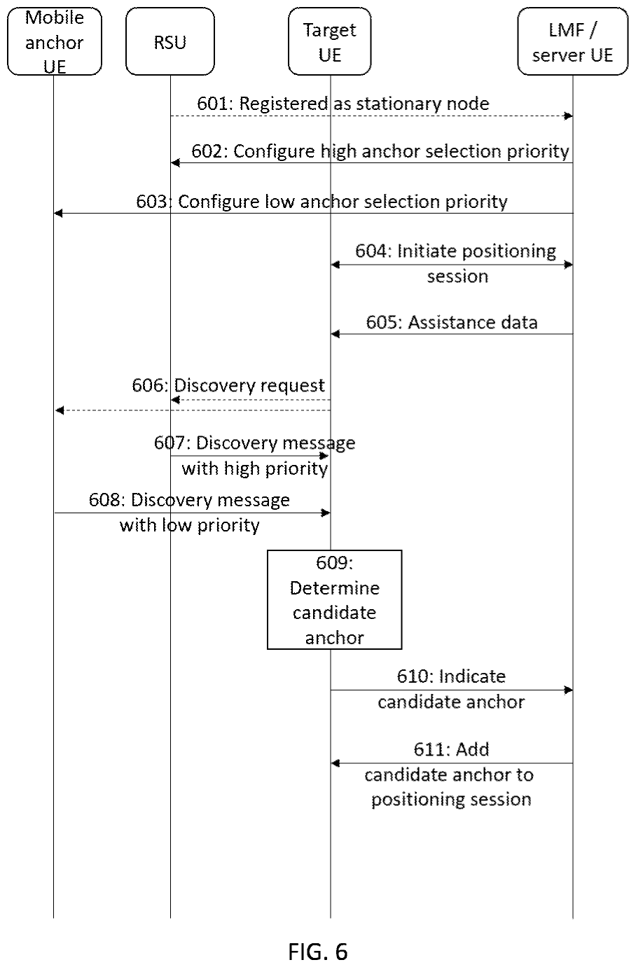

FIG. 6 illustrates a signal flow diagram according to an example embodiment, wherein the anchor selection is based on anchor selection priority. The target UE of FIG. 6 may correspond to UE 100 or 102 of FIG. 1, or the first target UE 200 or second target UE 202 of FIG. 2. The LMF or server UE of FIG. 6 may correspond to the core network 110 of FIG. 1, or the LMF 210 of FIG. 2. The RSU of FIG. 6 may correspond to at least one of the active positioning anchors 221, 222, 223 of FIG. 2. The mobile anchor UE of FIG. 6 may correspond to at least one of the inactive positioning anchors 231, 232 of FIG. 2.

Referring to FIG. 6, at 601, at least one active positioning anchor, such as a static RSU or static anchor UE, may transmit, to a location management entity, such as an LMF or server UE, a message for registering the at least one active positioning anchor as a permanently active stationary node (i.e., a permanently active positioning anchor). At 602, the location management entity configures the at least one active positioning anchor with a high anchor selection priority due to its stationary status.

At 603, the location management entity configures at least one inactive positioning anchor, such as a mobile anchor UE with a low anchor selection priority due to its mobile status.

In other words, in this case, the priority of the at least one active positioning anchor (stationary anchor) is higher than the priority of the at least one inactive positioning anchor (mobile anchor).

At 604, the location management entity initiates a positioning session for positioning a target UE.

At 605, the location management entity may transmit assistance data to the target UE for example via LPP to assist the target UE with determining at least one candidate positioning anchor for the target UE.

For example, the assistance data may comprise information indicating the at least one active positioning anchor, which may be configured to support positioning of another target UE.

Alternatively, or additionally, the location management entity may determine one or more conditions for assisting the target UE to determine at least one candidate positioning anchor for supporting positioning of the target UE, in which case the assistance data may comprise information indicating the one or more conditions.

At 606, in case of model-B discovery, the target UE may transmit a discovery request message to the at least one active positioning anchor and the at least one inactive positioning anchor (e.g., by broadcast or groupcast or unicast transmission). However, it should be noted that the discovery request message may be optional. For example, it may not be used in model-A discovery.

At 607, the at least one active positioning anchor transmits a discovery message to the target UE to indicate that the at least one active positioning anchor is capable of supporting the positioning of the target UE. The discovery message transmitted by the at least one active positioning anchor may further indicate that the at least one active positioning anchor is associated with the high anchor selection priority. At 608, the at least one inactive positioning anchor transmits a discovery message to the target UE to indicate that the at least one inactive positioning anchor is capable of supporting the positioning of the target UE. The discovery message transmitted by the at least one active positioning anchor may further indicate that the at least one active positioning anchor is associated with the low anchor selection priority.

For example, the discovery messages may be transmitted in response to receiving the discovery request message from the target UE (in case of model-B discovery). Alternatively, in case of model-A discovery, the anchors may autonomously transmit the discovery message (e.g., by broadcasting it periodically).

At 609, the target UE determines, based on the information received at 605, the priority indicated at 607 and 608, and the one or more conditions, at least one candidate positioning anchor from one or more discovered candidate positioning anchors (e.g., the at least one active positioning anchor and the at least one inactive positioning anchor) for supporting positioning of the target UE, wherein the at least one candidate positioning anchor comprises the at least one active positioning anchor or the at least one inactive positioning anchor.

In other words, the target UE evaluates the one or more conditions to determine whether to reuse the at least one active positioning anchor, or to activate the at least one inactive positioning anchor. The one or more conditions may be pre-defined or pre-configured at the target UE, or they may be indicated in the assistance data that may be received from the location management entity.

For example, if the one or more conditions are not fulfilled, the target UE may select the at least one active positioning anchor as the at least one candidate positioning anchor, since the at least one active positioning anchor is associated with a higher priority than the at least one inactive positioning anchor. Thus, the target UE may filter the discovered candidate positioning anchors based on the priority.

As another example, if the one or more conditions are fulfilled, the target UE may select the at least one inactive positioning anchor as the at least one candidate positioning anchor, even though the at least one inactive positioning anchor is associated with a lower priority than the at least one active positioning anchor.

Some examples of the one or more conditions and how to apply them are described above with reference to FIG. 3.

At 610, the target UE transmits, to the location management entity, a message (e.g., anchor discovery report) indicating a discovery of the at least one candidate positioning anchor. The message may also indicate the priority associated with the at least one candidate positioning anchor. The message may be transmitted for example via LPP.

At 611, in response to receiving the message from the target UE, the location management entity transmits (e.g., via LPP), to the target UE, an indication to add the at least one candidate positioning anchor to the positioning session of the target UE.

In other words, in case the at least one active positioning anchor is selected as the at least one candidate positioning anchor, the at least one active positioning anchor is reused for positioning the target UE.

In case the at least one inactive positioning anchor is selected as the at least one candidate positioning anchor, the at least one inactive positioning anchor is activated to support the positioning of the target UE. For example, the target UE may transmit an indication to the at least one inactive positioning anchor to activate to the at least one inactive positioning anchor, and the at least one inactive positioning anchor may then start transmitting PRS or SL-PRS (i.e., become active) based on receiving the indication.

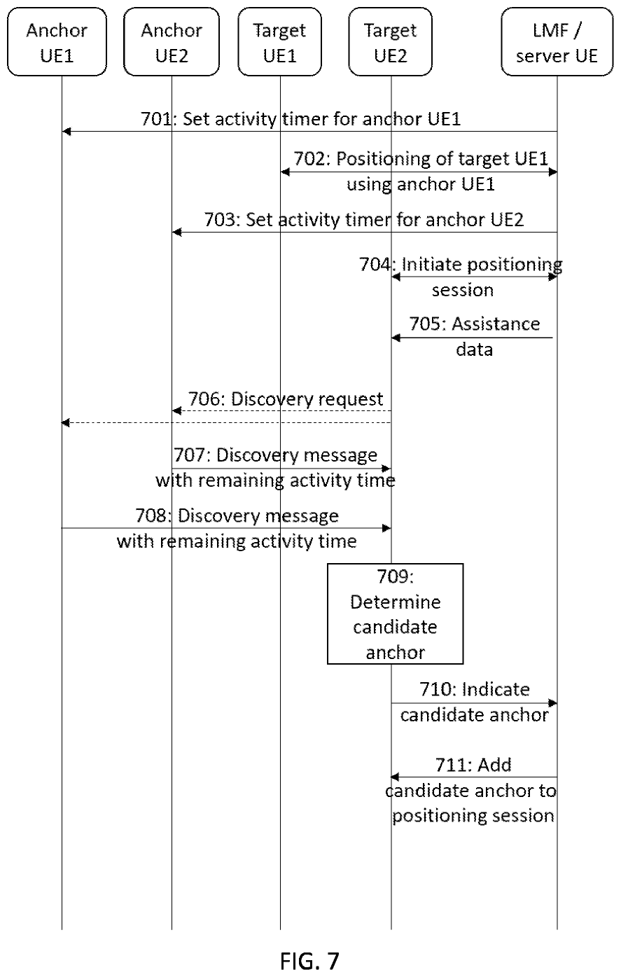

FIG. 7 illustrates a signal flow diagram according to an example embodiment, wherein the anchor selection is based on (remaining) activity time. The first target UE (target UE1) of FIG. 7 may correspond to UE 100 of FIG. 1, or the first target UE 200 of FIG. 2. The second target UE (target UE2) of FIG. 7 may correspond to UE 102 of FIG. 2, or the second target UE 202 of FIG. 2. The LMF or server UE of FIG. 7 may correspond to the core network 110 of FIG. 1, or the LMF 210 of FIG. 2. The first positioning anchor (anchor UE1) of FIG. 7 may correspond to one of the active positioning anchors 221, 222, 223 of FIG. 2. The second positioning anchor (anchor UE2) of FIG. 7 may correspond to one of the active positioning anchors 221, 222, 223 of FIG. 2, or one of the inactive positioning anchors 231, 232 of FIG. 2.

Referring to FIG. 7, at 701, a location management entity, such as an LMF or server UE, configures a first positioning anchor (anchor UE1) with a first activity timer. For example, the first activity timer may indicate a duration of PRS or SL-PRS transmission from the first positioning anchor.

At 702, the location management entity is engaged in positioning a first target UE (target UE1) by using at least the first positioning anchor. In other words, the first positioning anchor may be an active positioning anchor.

At 703, the location management entity configures a second positioning anchor (anchor UE2) with a second activity timer. For example, the second activity timer may indicate a duration of PRS or SL-PRS transmission from the second positioning anchor. The duration of the second activity timer may be the same or different than the first activity timer.

At 704, the location management entity initiates a positioning session for positioning a second target UE (target UE2).

At 705, the location management entity may transmit assistance data to the second target UE for example via LPP to assist the second target UE with determining at least one candidate positioning anchor for the second target UE.

For example, the assistance data may comprise information indicating the first positioning anchor, which may be configured to support positioning of the first target UE.

Alternatively, or additionally, the location management entity may determine one or more conditions for assisting the second target UE to determine at least one candidate positioning anchor for supporting positioning of the second target UE, in which case the assistance data may comprise information indicating the one or more conditions.

At 706, in case of model-B discovery, the second target UE may transmit a discovery request message to the first positioning anchor and the second positioning anchor (e.g., by broadcast or groupcast or unicast transmission). However, it should be noted that the discovery request message may be optional. For example, it may not be used in model-A discovery.

At 707, the first positioning anchor transmits a discovery message to the second target UE to indicate that the first positioning anchor is capable of supporting the positioning of the second target UE. The discovery message transmitted by the first positioning anchor may further indicate the PRS or SL-PRS broadcast duration of the first positioning anchor (e.g., time since PRS broadcast start), or the remaining activity time of the first activity timer.

At 708, the second positioning anchor transmits a discovery message to the second target UE to indicate that the second positioning anchor is capable of supporting the positioning of the second target UE. The discovery message transmitted by the second positioning anchor may further indicate the PRS or SL-PRS broadcast duration of the second positioning anchor (e.g., time since PRS broadcast start), or the remaining activity time of the second activity timer. The second positioning anchor may be an active or inactive positioning anchor. In case the second positioning anchor is an inactive anchor, then the remaining activity time may be zero.

For example, the discovery messages may be transmitted in response to receiving the discovery request message from the second target UE (in case of model-B discovery). Alternatively, in case of model-A discovery, the anchors may autonomously transmit the discovery message (e.g., by broadcasting it periodically).

At 709, the second target UE determines, based on the information received at 705, the broadcast duration or remaining activity time indicated at 707 and 708, and the one or more conditions, at least one candidate positioning anchor from one or more discovered candidate positioning anchors (e.g., the first positioning anchor and the second positioning anchor) for supporting positioning of the second target UE, wherein the at least one candidate positioning anchor comprises the first positioning anchor or the second positioning anchor.

In other words, the second target UE evaluates the one or more conditions to determine whether to reuse an active positioning anchor (e.g., the first positioning anchor), or to activate at least one inactive positioning anchor. The one or more conditions may be pre-defined or pre-configured at the second target UE, or they may be indicated in the assistance data that may be received from the location management entity.

For example, if the one or more conditions are not fulfilled, and both the first positioning anchor and the second positioning anchor are active positioning anchors, the second target UE may select the positioning anchor with the longest remaining activity time, or smallest PRS broadcast duration, as the at least one candidate positioning anchor.

Some examples of the one or more conditions and how to apply them are described above with reference to FIG. 3.

At 710, the second target UE transmits, to the location management entity, a message (e.g., anchor discovery report) indicating a discovery of the at least one candidate positioning anchor. The message may also indicate the PRS broadcast duration or remaining activity time associated with the at least one candidate positioning anchor. The message may be transmitted for example via LPP.

At 711, in response to receiving the message from the second target UE, the location management entity transmits (e.g., via LPP), to the second target UE, an indication to add the at least one candidate positioning anchor to the positioning session of the second target UE.

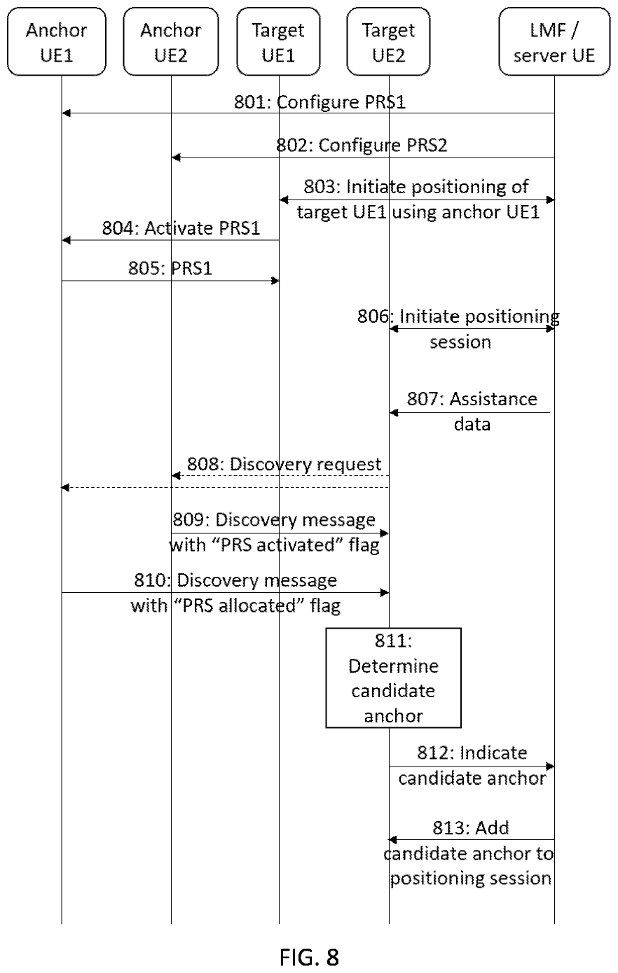

FIG. 8 illustrates a signal flow diagram according to an example embodiment, wherein the anchor selection is based on activity status. The first target UE (target UE1) of FIG. 8 may correspond to UE 100 of FIG. 1, or the first target UE 200 of FIG. 2. The second target UE (target UE2) of FIG. 8 may correspond to UE 102 of FIG. 2, or the second target UE 202 of FIG. 2. The LMF or server UE of FIG. 8 may correspond to the core network 110 of FIG. 1, or the LMF 210 of FIG. 2. The first positioning anchor (anchor UE1) of FIG. 8 may correspond to one of the active positioning anchors 221, 222, 223 of FIG. 2. The second positioning anchor (anchor UE2) of FIG. 8 may correspond to one of the active positioning anchors 221, 222, 223 of FIG. 2, or one of the inactive positioning anchors 231, 232 of FIG. 2.

Referring to FIG. 8, at 801, a location management entity, such as an LMF or server UE, configures a first positioning anchor (anchor UE1) with a first PRS or SL-PRS configuration.

At 802, the location management entity configures a second positioning anchor (anchor UE2) with a second PRS or SL-PRS configuration. The second PRS or SL-PRS configuration may be the same or different than the first PRS or SL-PRS configuration.

At 803, the location management entity is engaged in positioning a first target UE (target UE1) by using at least the first positioning anchor. In other words, the first positioning anchor may be an active positioning anchor.

At 804, the first target UE transmits, to the first positioning anchor, an indication to activate the first PRS or SL-PRS configuration.

At 805, based on receiving the indication from the first target UE, the first positioning anchor starts broadcasting PRS or SL-PRS based on the first PRS or SL-PRS configuration.

At 806, the location management entity initiates a positioning session for positioning a second target UE (target UE2).

At 807, the location management entity may transmit assistance data to the second target UE for example via LPP to assist the second target UE with determining at least one candidate positioning anchor for the second target UE.

For example, the assistance data may comprise information indicating the first positioning anchor, which may be configured to support positioning of the first target UE.

Alternatively, or additionally, the location management entity may determine one or more conditions for assisting the second target UE to determine at least one candidate positioning anchor for supporting positioning of the second target UE, in which case the assistance data may comprise information indicating the one or more conditions.

At 808, in case of model-B discovery, the second target UE may transmit a discovery request message to the first positioning anchor and the second positioning anchor (e.g., by broadcast or groupcast or unicast transmission). However, it should be noted that the discovery request message may be optional. For example, it may not be used in model-A discovery.

At 809, the first positioning anchor transmits a discovery message to the second target UE to indicate that the first positioning anchor is capable of supporting the positioning of the second target UE. The discovery message transmitted by the first positioning anchor may further indicate the active status of the first positioning anchor (i.e., that the first positioning anchor is broadcasting PRS or SL-PRS), for example by including a “PRS activated” flag in the discovery message.

At 810, the second positioning anchor transmits a discovery message to the second target UE to indicate that the second positioning anchor is capable of supporting the positioning of the second target UE. The discovery message transmitted by the second positioning anchor may further indicate the status of the second positioning anchor, for example by including a “PRS allocated” flag in the discovery message. The “PRS allocated” flag indicates that the second positioning anchor is inactive but it has been allocated with PRS or SL-PRS resources (i.e., configured with the second PRS or SL-PRS configuration).

For example, the discovery messages may be transmitted in response to receiving the discovery request message from the second target UE (in case of model-B discovery). Alternatively, in case of model-A discovery, the anchors may autonomously transmit the discovery message (e.g., by broadcasting it periodically).

At 811, the second target UE determines, based on the information received at 807, the activity status indicated at 809 and 810, and the one or more conditions, at least one candidate positioning anchor from one or more discovered candidate positioning anchors (e.g., the first positioning anchor and the second positioning anchor) for supporting positioning of the second target UE, wherein the at least one candidate positioning anchor comprises the first positioning anchor or the second positioning anchor.

In other words, the second target UE evaluates the one or more conditions to determine whether to reuse an active positioning anchor (e.g., the first positioning anchor), or to activate at least one inactive positioning anchor (e.g., the second positioning anchor). The one or more conditions may be pre-defined or pre-configured at the second target UE, or they may be indicated in the assistance data that may be received from the location management entity.

For example, if the one or more conditions are not fulfilled (e.g., high channel usage and/or low priority of the positioning session), the second target UE may select the first positioning anchor as the at least one candidate positioning anchor (i.e., reuse the active anchor), since the first positioning anchor is active and the second positioning anchor is inactive.

As another example, if the one or more conditions are fulfilled (e.g., low channel usage and/or high priority of the positioning session), the second target UE may select the second positioning anchor as the at least one candidate positioning anchor (i.e., activate a new anchor), since the second positioning anchor is inactive and the first positioning anchor is active.

Some examples of the one or more conditions and how to apply them are described above with reference to FIG. 3.

At 812, the second target UE transmits, to the location management entity, a message (e.g., anchor discovery report) indicating a discovery of the at least one candidate positioning anchor. The message may also indicate the activation status (e.g., “PRS activated” or “PRS allocated”) associated with the at least one candidate positioning anchor. The message may be transmitted for example via LPP.

At 813, in response to receiving the message from the second target UE, the location management entity transmits (e.g., via LPP), to the second target UE, an indication to add the at least one candidate positioning anchor to the positioning session of the second target UE.

The blocks, related functions, and information exchanges (messages) described above by means of FIGS. 3-8 are in no absolute chronological order, and some of them may be performed simultaneously or in an order differing from the described one. Other functions can also be executed between them or within them, and other information may be sent, and/or other rules applied. Some of the blocks or part of the blocks or one or more pieces of information can also be left out or replaced by a corresponding block or part of the block or one or more pieces of information.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

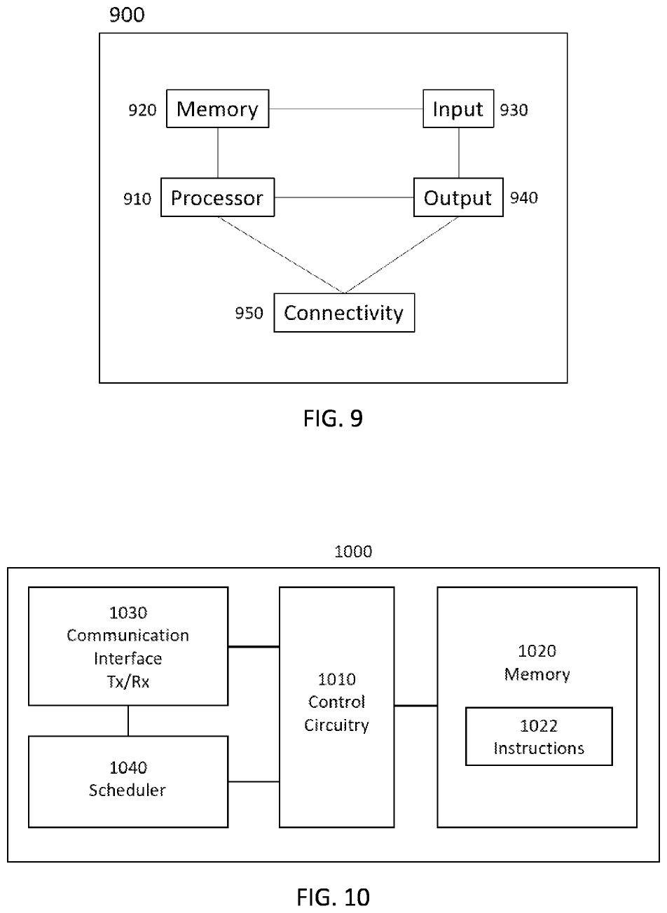

FIG. 9 illustrates an example of an apparatus 900 comprising means for performing one or more of the example embodiments described above. For example, the apparatus 900 may be an apparatus such as, or comprising, or comprised in, a user device. The user device may also be called a wireless communication device, a subscriber unit, a mobile station, a remote terminal, an access terminal, a user terminal, a terminal device, user equipment (UE), target UE, or anchor UE. The user device may correspond to one of the UEs 100, 102 of FIG. 1, or one of the target UEs 200, 202 of FIG. 2, or one of the anchor UEs 221, 222, 223, 231, 232 of FIG. 2.

The apparatus 900 may comprise a circuitry or a chipset applicable for realizing one or more of the example embodiments described above. For example, the apparatus 900 may comprise at least one processor 910. The at least one processor 910 interprets instructions (e.g., computer program instructions) and processes data. The at least one processor 910 may comprise one or more programmable processors. The at least one processor 910 may comprise programmable hardware with embedded firmware and may, alternatively or additionally, comprise one or more application-specific integrated circuits (ASICs).

The at least one processor 910 is coupled to at least one memory 920. The at least one processor is configured to read and write data to and from the at least one memory 920. The at least one memory 920 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The at least one memory 920 stores computer readable instructions that are executed by the at least one processor 910 to perform one or more of the example embodiments described above. For example, non-volatile memory stores the computer readable instructions, and the at least one processor 910 executes the instructions using volatile memory for temporary storage of data and/or instructions. The computer readable instructions may refer to computer program code.

The computer readable instructions may have been pre-stored to the at least one memory 920 or, alternatively or additionally, they may be received, by the apparatus, via an electromagnetic carrier signal and/or may be copied from a physical entity such as a computer program product. Execution of the computer readable instructions by the at least one processor 910 causes the apparatus 900 to perform one or more of the example embodiments described above. That is, the at least one processor and the at least one memory storing the instructions may provide the means for providing or causing the performance of any of the methods and/or blocks described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer. The term “non-transitory,” as used herein, is a limitation of the medium itself (i.e., tangible, not a signal) as opposed to a limitation on data storage persistency (e.g., RAM vs. ROM).

The apparatus 900 may further comprise, or be connected to, an input unit 930. The input unit 930 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 930 may comprise an interface to which external devices may connect to.

The apparatus 900 may also comprise an output unit 940. The output unit may comprise or be connected to one or more displays capable of rendering visual content, such as a light emitting diode (LED) display, a liquid crystal display (LCD) and/or a liquid crystal on silicon (LCoS) display. The output unit 940 may further comprise one or more audio outputs. The one or more audio outputs may be for example loudspeakers.

The apparatus 900 further comprises a connectivity unit 950. The connectivity unit 950 enables wireless connectivity to one or more external devices. The connectivity unit 950 comprises at least one transmitter and at least one receiver that may be integrated to the apparatus 900 or that the apparatus 900 may be connected to. The at least one transmitter comprises at least one transmission antenna, and the at least one receiver comprises at least one receiving antenna. The connectivity unit 950 may comprise an integrated circuit or a set of integrated circuits that provide the wireless communication capability for the apparatus 900. Alternatively, the wireless connectivity may be a hardwired application-specific integrated circuit (ASIC). The connectivity unit 950 may also provide means for performing at least some of the blocks of one or more example embodiments described above. The connectivity unit 950 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

It is to be noted that the apparatus 900 may further comprise various components not illustrated in FIG. 9. The various components may be hardware components and/or software components.

FIG. 10 illustrates an example of an apparatus 1000 comprising means for performing one or more of the example embodiments described above. For example, the apparatus 1000 may be an apparatus such as, or comprising, or comprised in, a network node of a radio access network. The network node may correspond to the access node 104 of FIG. 1, or the network node 204 of FIG. 2.

The network node may also be referred to, for example, as a network element, a radio access network (RAN) node, a next generation radio access network (NG-RAN) node, a NodeB, an eNB, a gNB, a base transceiver station (BTS), a base station, an NR base station, a 5G base station, an access node, an access point (AP), a relay node, a repeater, an integrated access and backhaul (IAB) node, an IAB donor node, a distributed unit (DU), a central unit (CU), a baseband unit (BBU), a radio unit (RU), a radio head, a remote radio head (RRH), or a transmission and reception point (TRP).

The apparatus 1000 may comprise, for example, a circuitry or a chipset applicable for realizing one or more of the example embodiments described above. The apparatus 1000 may be an electronic device comprising one or more electronic circuitries. The apparatus 1000 may comprise a communication control circuitry 1010 such as at least one processor, and at least one memory 1020 storing instructions 1022 which, when executed by the at least one processor, cause the apparatus 1000 to carry out one or more of the example embodiments described above. Such instructions 1022 may, for example, include computer program code (software). The at least one processor and the at least one memory storing the instructions may provide the means for providing or causing the performance of any of the methods and/or blocks described above.

The processor is coupled to the memory 1020. The processor is configured to read and write data to and from the memory 1020. The memory 1020 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The memory 1020 stores computer readable instructions that are executed by the processor. For example, non-volatile memory stores the computer readable instructions, and the processor executes the instructions using volatile memory for temporary storage of data and/or instructions.

The computer readable instructions may have been pre-stored to the memory 1020 or, alternatively or additionally, they may be received, by the apparatus, via an electromagnetic carrier signal and/or may be copied from a physical entity such as a computer program product. Execution of the computer readable instructions causes the apparatus 1000 to perform one or more of the functionalities described above.

The memory 1020 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data, such as a current neighbour cell list, and, in some example embodiments, structures of frames used in the detected neighbour cells.

The apparatus 1000 may further comprise or be connected to a communication interface 1030, such as a radio unit, comprising hardware and/or software for realizing communication connectivity with one or more wireless communication devices according to one or more communication protocols. The communication interface 1030 comprises at least one transmitter (Tx) and at least one receiver (Rx) that may be integrated to the apparatus 1000 or that the apparatus 1000 may be connected to. The communication interface 1030 may provide means for performing some of the blocks for one or more example embodiments described above. The communication interface 1030 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

The communication interface 1030 provides the apparatus with radio communication capabilities to communicate in the wireless communication network. The communication interface may, for example, provide a radio interface to one or more wireless communication devices. The apparatus 1000 may further comprise or be connected to another interface towards a core network such as the network coordinator apparatus or AMF, and/or to the access nodes of the cellular communication system.

The apparatus 1000 may further comprise a scheduler 1040 that is configured to allocate radio resources. The scheduler 1040 may be configured along with the communication control circuitry 1010 or it may be separately configured.

It is to be noted that the apparatus 1000 may further comprise various components not illustrated in FIG. 10. The various components may be hardware components and/or software components.

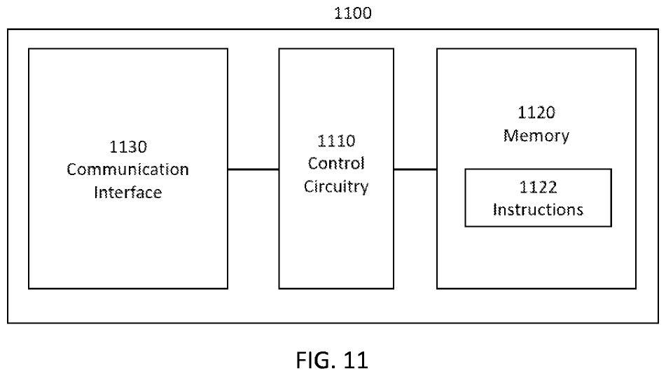

FIG. 11 illustrates an example of an apparatus 1100 of a core network, the apparatus 1100 comprising means for performing one or more of the example embodiments described above. For example, the means may be a location management function (LMF) of the core network or the means may be network function virtualization infrastructure. The apparatus 1100 may correspond to the core network 110 of FIG. 1, or the LMF 210 of FIG. 2.

The apparatus 1100 may comprise, for example, a circuitry or a chipset applicable for realizing one or more of the example embodiments described above. The apparatus 1100 may be an electronic device or computing system comprising one or more electronic circuitries. The apparatus 1100 may comprise a control circuitry 1110 such as at least one processor, and at least one memory 1120 storing instructions 1122 which, when executed by the at least one processor, cause the apparatus 1100 to carry out one or more of the example embodiments described above. The instructions 1122 may comprise instructions of the AMF. Such instructions 1122 may, for example, include computer program code (software). The at least one processor and the at least one memory storing the instructions may provide the means for providing or causing the performance of any of the methods and/or blocks described above.

The processor is coupled to the memory 1120. The processor is configured to read and write data to and from the memory 1120. The memory 1120 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The memory 1120 stores computer readable instructions that are executed by the processor. For example, non-volatile memory stores the computer readable instructions, and the processor executes the instructions using volatile memory for temporary storage of data and/or instructions.

The computer readable instructions may have been pre-stored to the memory 1120 or, alternatively or additionally, they may be received, by the apparatus, via an electromagnetic carrier signal and/or may be copied from a physical entity such as a computer program product. Execution of the computer readable instructions causes the apparatus 1100 to perform one or more of the functionalities described above.

The memory 1120 may be implemented using any suitable data storage technology, such as semiconductor-based memory devices, flash memory, magnetic memory devices and systems, optical memory devices and systems, fixed memory and/or removable memory.

The apparatus 1100 may further comprise or be connected to a communication interface 1130 comprising hardware and/or software for realizing communication connectivity according to one or more communication protocols. The communication interface 1130 may comprise at least one transmitter (Tx) and at least one receiver (Rx) that may be integrated to the apparatus 1100 or that the apparatus 1100 may be connected to. The communication interface 1130 may provide means for performing some of the blocks for one or more example embodiments described above. The communication interface 1130 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

The communication interface 1130 provides the apparatus with communication capabilities to communicate in the cellular communication system. The communication interface 1130 may, for example, provide a radio, cable or fiber interface to one or more network nodes of a radio access network.

It is to be noted that the apparatus 1100 may further comprise various components not illustrated in FIG. 11. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the example embodiments described above, but may vary within the scope of the claims. Therefore, all words and expressions should be interpreted broadly, and they are intended to illustrate, not to restrict, the embodiments.

### List of Abbreviations

4G: fourth generation
5G: new radio/fifth generation
6G: sixth generation
AP: access point
DL: downlink
UL: uplink
SL: sidelink
NR: new radio
LTE: long term evolution
LTE-A: long term evolution advanced
UMTS: universal mobile telecommunications system
UTRAN: UMTS radio access network
WLAN: wireless local area network
WiMAX: worldwide interoperability for microwave access
PCS: personal communications services
WCDMA: wideband code division multiple access
UWB: ultra-wideband
MANET: mobile ad-hod network
IMS: internet protocol multimedia subsystem
eNB: evolved NodeB/4G base station
gNB: next generation NodeB/5G base station
CN: core network
NGC: next generation core
S-GW: serving gateway
P-GW: packet data network gateway
UE: user equipment
MME: mobility management entity
SIM: subscriber identification module
PDA: personal digital assistant
IoT: internet of things
MIMO: multiple input and multiple output
mMTC: massive machine-type communications
RI: radio interface
RAT: radio access technology
MEC: multi-access edge computing
RAN: radio access network
NFV: network function virtualization
SDN: software defined networking
DU: distributed unit
CU: central unit
M2M: machine-to-machine
GEO: geostationary earth orbit
LEO: low earth orbit
HNB-GW: home node B gateway
RAM: random-access memory
DRAM: dynamic random-access memory
SDRAM: synchronous dynamic random-access memory
ROM: read-only memory
PROM: programmable read-only memory
EEPROM: electronically erasable programmable read-only memory
LED: light emitting diode
LCD: liquid crystal display
LCOS: liquid crystal on silicon
ASIC: application-specific integrated circuit
DFE: digital front end
ADC: analog-to-digital converter
DAC: digital-to-analog converter
RU: radio unit
TRX: transceiver
TRP: transmission and reception point
TX: transmitter
RX: receiver
L1: Layer 1
L2: Layer 2
L3: Layer 3
BBU: baseband unit
RAP: radio access point
vCU: virtualized central unit
vDU: virtualized distributed unit
CSSP: customer-specific standard product
SoC: system-on-a-chip
DSP: digital signal processor
DSPD: digital signal processing device
PLD: programmable logic device
FPGA: field programmable gate array
GPU: graphics processing unit
RRC: radio resource control
SDAP: service data adaptation protocol
PDCP: packet data convergence protocol
RLC: radio link control
MAC: medium access control
PHY: physical
CU-CP: central unit control plane
CU-UP: central unit user plane
IAB: integrated access and backhaul
MT: mobile termination
RRH: remote radio head
AMF: access and mobility management function
UPF: user plane function
LMF: location management function
MO-LR: mobile-originated location request
MT-LR: mobile-terminated location request
AN: access node
TDoA: time difference of arrival
TOA: time of arrival
TOD: time of departure
RTT: round trip time
AoD: angle of departure
AoA: angle of arrival
PRS: positioning reference signal
SL-PRS: sidelink positioning reference signal
SRS: sounding reference signal
V2X: vehicle-to-everything
IIoT: industrial internet of things
GDOP: geometric dilution of precision
LPP: LTE positioning protocol
RSRP: reference signal received power
SINR: signal-to-interference-plus-noise ratio
ProSe: proximity service
SLPP: sidelink positioning protocol
RSU: road-side unit
VIP: very important person

1. An apparatus comprising at least one processor, and at least one memory storing instructions that, when executed by the at least one processor, cause the apparatus at least to:
receive information indicating at least one active positioning anchor configured to support positioning of one or more other apparatuses, wherein the information is received from at least one of: the at least one active positioning anchor, the one or more other apparatuses, a location management entity, or a network node;
determine, based on the information and one or more conditions, at least one candidate positioning anchor from one or more discovered candidate positioning anchors for supporting positioning of the apparatus, wherein the at least one candidate positioning anchor comprises the at least one active positioning anchor or at least one inactive positioning anchor; and
indicate, to the location management entity, a discovery of the at least one candidate positioning anchor.

2. The apparatus according to claim 1, wherein the information indicates a remaining activity time or a positioning reference signal broadcast duration of the at least one active positioning anchor,
wherein the at least one candidate positioning anchor is determined based at least partly on the remaining activity time or the positioning reference signal broadcast duration of the at least one active positioning anchor.

3. The apparatus according to claim 1, wherein the information indicates a priority of the at least one active positioning anchor relative to the at least one inactive positioning anchor,
wherein the at least one candidate positioning anchor is determined based at least partly on the priority.

4. The apparatus according to claim 1, further being caused to:
receive, from the at least one active positioning anchor, a message indicating a status of the at least one active positioning anchor with respect to at least one condition of the one or more conditions,
wherein the at least one candidate positioning anchor is determined based at least partly on the status of the at least one active positioning anchor.

5. The apparatus according to claim 1, wherein the at least one candidate positioning anchor comprises the at least one active positioning anchor based on the one or more conditions not being fulfilled.

6. The apparatus according to claim 1, wherein the at least one candidate positioning anchor comprises the at least one inactive positioning anchor based on the one or more conditions being fulfilled.

7. The apparatus according to claim 5, wherein the one or more conditions comprise at least one of: an estimated positioning accuracy improvement associated with the at least one active positioning anchor being below a threshold, or an estimated positioning error reduction associated with the at least one active positioning anchor being below a threshold.

8. The apparatus according to claim 5, wherein the one or more conditions comprise at least one of: one or more performance parameters required from the at least one active positioning anchor not being available, one or more performance guarantees required from the at least one active positioning anchor not being available, one or more performance requirements required from the at least one active positioning anchor not being available, or a performance class required from the at least one active positioning anchor not being available.

9. The apparatus according to claim 5, wherein the one or more conditions comprise at least one of: a type of a positioning-related application related to the apparatus, a type of a positioning session related to the apparatus, a type of the apparatus, a priority of the positioning-related application, a priority of the positioning session, a priority of the apparatus, a purpose of the positioning-related application, a purpose of the positioning session, or a purpose of the apparatus.

10. The apparatus according to claim 5, wherein the one or more conditions comprise at least one of: the at least one active positioning anchor not being detected, or the at least one inactive positioning anchor being detected.

11. The apparatus according to claim 5, wherein the one or more conditions comprise at least one of: channel usage being below a threshold, or interference being below a threshold.

12. The apparatus according to claim 5, wherein the one or more conditions comprise at least one of: availability of a positioning reference signal at the at least one inactive positioning anchor, usage of the positioning reference signal at the at least one inactive positioning anchor, a strength of the positioning reference signal of the at least one inactive positioning anchor being above a threshold, a signal-to-interference-plus-noise ratio of the positioning reference signal of the at least one inactive positioning anchor being above a threshold, or a type of the positioning reference signal of the at least one inactive positioning anchor corresponding to a desired type.

13. The apparatus according to claim 5, wherein the one or more conditions comprise at least one of: a resource pool type used by the apparatus, a resource configuration of the apparatus, or one or more resource parameters of the apparatus.

14. The apparatus according to claim 5, wherein the one or more conditions comprise at least one of: participation of the apparatus in session-based positioning, participation of the apparatus in positioning with one or more performance guarantees, or the apparatus not participating in session-less positioning.

15. An apparatus comprising at least one processor, and at least one memory storing instructions that, when executed by the at least one processor, cause the apparatus at least to:
determine one or more conditions for assisting a user device to determine at least one candidate positioning anchor for supporting positioning of the user device, wherein the at least one candidate positioning anchor comprises at least one active positioning anchor or at least one inactive positioning anchor;
transmit, to the user device, information indicating the one or more conditions; and
transmit, to the user device, information indicating the at least one active positioning anchor for assisting the user device to determine the at least one candidate positioning anchor, the at least one active positioning anchor configured to support positioning of one or more other user devices.

16. The apparatus according to claim 15, wherein the information indicating the at least one active positioning anchor is based on information received from the one or more other user devices, or based on operating conditions of the apparatus.

17. A method comprising:
receiving, by an apparatus, information indicating at least one active positioning anchor configured to support positioning of one or more other apparatuses, wherein the information is received from at least one of: the at least one active positioning anchor, the one or more other apparatuses, a location management entity, or a network node;
determining, by the apparatus, based on the information and one or more conditions, at least one candidate positioning anchor from one or more discovered candidate positioning anchors for supporting positioning of the apparatus, wherein the at least one candidate positioning anchor comprises the at least one active positioning anchor or at least one inactive positioning anchor; and
indicating, by the apparatus, to the location management entity, a discovery of the at least one candidate positioning anchor.
